(19) United States
(12) Patent Application Publication
(10) Pub. No.: US 2011/0048177 A1
(43) Pub. Date: Mar. 3, 2011

(54) Wrench with a sheath

(76) Inventor: Chia-Yun Lin, Taichung (TW)

(21) Appl. No.: 12/461,885

(22) Filed: Aug. 27, 2009

(51) Int. Cl. B25B 23/16; B25B 13/02; B25B 13/46; B25G 1/00

(52) U.S. Cl. 81/58; 81/184; 81/125.1; 81/177.1

(57) ABSTRACT

A wrench with a sheath has a wrench body and a sheath. The wrench body has a handle. The sheath is made of non-rubber material that includes any plastic material being able to be applied for an injection molding method except rubber inseparably formed around the handle by the injection molding method and has a surface.

### BACKGROUND OF THE INVENTION

1. Field of the Invention

The present invention relates to a wrench, and more particularly to a wrench with a sheath.

2. Description of Related Art

Wrenches are used to rotate fasteners. However, a conventional wrench comprises a handle that is metal. In cold and hot weather, the handle is cooled or heated so risks causing frostbite or scalding. Moreover, because the handle is polygonal in cross section, the wrench may causes chafing and blistering.

To overcome the shortcomings, the present invention tends to provide a wrench with a sheath to mitigate or obviate the aforementioned problems.

### SUMMARY OF THE INVENTION

A wrench with a sheath has a wrench body and a sheath. The wrench body has a handle. The sheath is made of non-rubber material that includes any plastic material being able to be applied for an injection molding method except rubber inseparably formed around the handle by the injection molding method and has a surface. Therefore, the sheath can decrease abrasion between a hand and the handle to prevent chafing and blistering and is selected to be comfortable to hold regardless of ambient temperature.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a wrench with a sheath in accordance with the present invention; and

FIG. 2 is a perspective view of a second embodiment of the wrench in accordance with the present invention.

### DETAILED DESCRIPTION OF PREFERRED EMBODIMENT

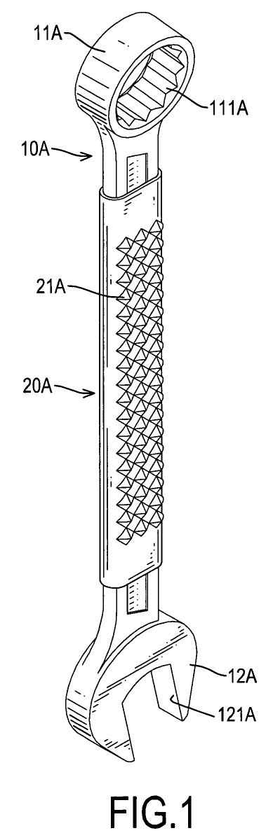

With reference to FIG. 1, a first embodiment of a wrench with a sheath in accordance with the present invention comprises a wrench body (10A) and a sheath (20A). The wrench body (10A) comprises two ends, a box head (11A), a wrench head (12A) and a handle. The box head (11A) and the wrench head (12A) are mounted respectively on the two ends of the wrench body (10A). The box head (11A) is composed of a circular loop and has an inner peripheral surface and multiple teeth (111A). The multiple teeth (111A) are formed around the inner peripheral surface of the box head (11A). The wrench head (12A) has an opening (121A). The opening (121A) is defined in the wrench head (12A). The handle is connected between the box head (11A) and the wrench head (12A).

The sheath (20A) is made of non-rubber material, is inseparably formed around the handle and has a surface and multiple protrusions (21A). Wherein, the non-rubber material includes any plastic material being able to be applied for an injection molding method except rubber and the sheath (20A) may be polyethylene or polypropylene material. The protrusions (21A) integrally protrude from the surface of the sheath (20A). In this embodiment, each protrusion (21A) is a rhombus.

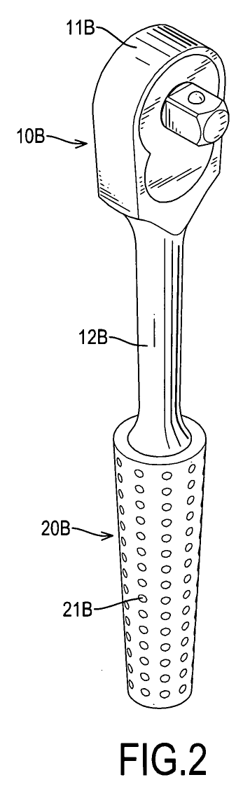

With reference to FIG. 2, in a second embodiment, the wrench with a sheath comprises a wrench body (10B) and a sheath (20B). The wrench body (10B) has a driving end (11B), a connecting shaft (12B) and a handle. The connecting shaft (12B) is connected with the driving end (11B). The handle is a cylinder, is connected with the connecting shaft (12B) and is opposite to the driving end (11B).

The sheath (20B) is made of non-rubber material, is inseparably formed around the handle and has a surface and multiple protrusions (21B). Wherein, the non-rubber material includes any plastic material being able to be applied for the injection molding method except rubber and the sheath (21B) may be polyethylene or polypropylene material. The protrusions (21B) integrally protrude from and are formed around the surface of the sheath (20B). In this embodiment, each protrusion (21B) is semispherical.

The sheath (20A, 20B) of present invention is directly mounted on the handle by the injection molding so the sheath (20A, 20B) matches the handle to avoid sliding off the handle. Therefore, the sheath (20A, 20B) can decrease abrasion between a hand and the handle to prevent frostbite and scalding.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wrench with a sheath comprising:
a wrench body having a handle; and
a sheath made of non-rubber material that includes any plastic material being able to be applied for an injection molding method except rubber inseparably formed around the handle by the injection molding method and having a surface.

2. The wrench with a sheath as claimed in claim 1, wherein the sheath further has multiple protrusions integrally protruding from the surface of the sheath.

3. The wrench with a sheath as claimed in claim 2, wherein each protrusion is a rhombus.

4. The wrench with a sheath as claimed in claim 1, wherein the wrench body comprises
two ends;
a box head composed of a circular loop mounted on one of the ends and having
an inner peripheral surface;
multiple teeth formed around the inner peripheral surface of the box head;
a wrench head mounted on the other end and having an opening defined in the wrench head; and
a handle connected between the box head and the wrench head.

5. The wrench with a sheath as claimed in claim 2, wherein the wrench body comprises
two ends;
a box head composed of a circular loop mounted on one of the ends and having
an inner peripheral surface;
multiple teeth formed around the inner peripheral surface of the box head;
a wrench head mounted on the other end and having an opening defined in the wrench head; and
a handle connected between the box head and the wrench head.

6. The wrench with a sheath as claimed in claim 3, wherein the wrench body comprises
two ends;
a box head composed of a circular loop mounted on one of the ends and having
an inner peripheral surface;
multiple teeth formed around the inner peripheral surface of the box head;
a wrench head mounted on the other end and having an opening defined in the wrench head; and
a handle connected between the box head and the wrench head.

7. The wrench with a sheath as claimed in claim 2, wherein the handle is a cylinder is mounted around the handle, and each protrusion is a semispherical.

8. The wrench with a sheath as claimed in claim 1, wherein the wrench body has
a driving end;
a connecting shaft connected with the driving end; and
the handle connected with the connecting shaft opposite to the driving end.

9. The wrench with a sheath as claimed in claim 2, wherein the wrench body has
a driving end;
a connecting shaft connected with the driving end; and
the handle connected with the connecting shaft opposite to the driving end.

10. The wrench with a sheath as claimed in claim 7, wherein the wrench body has
a driving end;
a connecting shaft connected with the driving end; and
the handle connected with the connecting shaft opposite to the driving end.

11. The wrench with a sheath as claimed in claim 1, wherein the sheath is polyethylene or polypropylene material.

12. The wrench with a sheath as claimed in claim 2, wherein the sheath is polyethylene or polypropylene material.

13. The wrench with a sheath as claimed in claim 3, wherein the sheath is polyethylene or polypropylene material.

14. The wrench with a sheath as claimed in claim 6, wherein the sheath is polyethylene or polypropylene material.

15. The wrench with a sheath as claimed in claim 7, wherein the sheath is polyethylene or polypropylene material.

16. The wrench with a sheath as claimed in claim 10, wherein the sheath is polyethylene or polypropylene material.
